(19) United States
(12) Patent Application Publication
(10) Pub. No.: US 2016/0142397 A1
(43) Pub. Date: May 19, 2016

(54) System for Providing an Indication of the Validity of the Identity of an Individual

(71) Applicant: Bank of America Corporation, Charlotte, NC (US)

(72) Inventors: Craig Froelich, Thousand Oaks, CA (US); Suresh G. Nair, Robbinsville, NJ (US); Kurt D. Newman, Matthews, NC (US)

(21) Appl. No.: 15/005,521

(22) Filed: Jan. 25, 2016

Related U.S. Application Data
(63) Continuation of application No. 12/871,873, filed on Aug. 30, 2010.
(60) Provisional application No. 61/292,123, filed on Jan. 4, 2010.

(51) Int. Cl. H04L 29/06

(52) U.S. Cl. CPC H04L 63/08

(57) ABSTRACT

Aspects of this disclosure relate to an identity level generating computer which may include a processor and memory storing computer executable instructions that, when executed, cause the computer to generate identity levels for users of a business. Generating identity levels for users of a business may include electronically receiving user data regarding at least one of: an identity of the user, a behavior of the user, a propensity of a user and a risk associated with the user's identity and determining one or more individual characteristic levels based on the electronically received information. Determining the one or more individual characteristic levels may include comparing the customer data regarding the at least one of the identity of the user, the behavior of the user, the propensity of the user and the risk associated with the user's identity with a list predetermined criteria and calculating an identity level based on the comparison of the user data with the list predetermined criteria.

This application is a continuation of and claims priority to U.S. patent application Ser. No. 12/871,873, filed Aug. 30, 2010 and entitled “Providing an Indication of the Validity of the Identity of an Individual,” which claims priority to U.S. Provisional Patent Application No. 61/292,123, filed Jan. 4, 2010 and entitled “Providing an Indication of the Validity of the Identity of an Individual,” the contents of which are incorporated herein by reference in their entirety.

### FIELD OF DISCLOSURE

Aspects of the present disclosure relate generally to systems for providing an indication of the validity of the identity of an individual. Particular aspects of the present disclosure relate to providing an indication of the validity of the identity of an individual conducting an electronic record.

### BACKGROUND

Recent years have seen an increased growth of electronic interaction (e.g., electronic interaction between a user and an organization, such as in an electronic record; electronic interaction between different people, such as through social networking websites; and the like). While such electronic interaction provides many benefits for the parties involved (e.g., convenience, efficiency, and the like), the electronic interaction may also present an increased risk of unauthorized activity. For example, an individual conducting an electronic record may use a false name or other inaccurate or unauthorized information in conducting the record. Therefore, it would be advantageous to have a system that provides an indication of the validity of the identity of an individual involved in an electronic interaction (e.g., a user conducting an electronic record). Such a system would increase the likelihood that an individual's identity is legitimate and, therefore, provide a greater level of assurance that the individual involved in the electronic interaction is, in fact, whom they claim to be.

### SUMMARY

Therefore, aspects of this disclosure relate to an identity level generating computer which may include a processor and memory storing computer executable instructions that, when executed, cause the computer to generate identity levels for users of a business. Generating identity levels for users of a business may include electronically receiving user data regarding at least one of: an identity of the user, a behavior of the user, a propensity of the user and a risk associated with the user's identity and determining one or more individual characteristic levels based on the electronically received information. According to aspects of this disclosure, determining the one or more individual characteristic levels may include comparing the user data regarding the at least one of the identity of the user, the behavior of the user, the propensity of the user and the risk associated with the user's identity with a list predetermined criteria and calculating an identity level based on the comparison of the user data with the list predetermined criteria.

Further aspects of this disclosure relate to an identity level generating computer which may include a processor and memory storing computer executable instructions that, when executed, cause the computer to generate identity levels for users of a business. Generating identity levels for users of a business may include electronically receiving user data regarding at least one of: an identity of the user, a behavior of the user, a propensity of the user and a risk associated with the user's identity and determining one or more individual characteristic levels based on the electronically received information. According to aspects of this disclosure, determining the one or more individual characteristic levels may include providing the user with base individual characteristic level, comparing the user data regarding the at least one of the identity of the user, the behavior of the user, the propensity of the user and the risk associated with the user's identity with a list predetermined criteria, and increasing or decreasing the base individual characteristic level based on the comparison of the user data with the list of predetermined criteria. Further, the system may determine the identity levels based on the one or more individual characteristic levels.

### BRIEF DESCRIPTION OF THE DRAWINGS

FIG. 1 illustrates a diagram of a general-purpose digital computing environment in which certain aspects of the present disclosure may be implemented;

FIG. 2 illustrates a block diagram of a computing environment in which certain aspects of the present disclosure may be implemented; and

FIG. 3 illustrates a flow chart which illustrates an illustrative method for creating an identity level for according to aspects of the disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made.

It is noted that throughout the disclosure, the term bank may be used interchangeably with organization, financial institution, business, and the like. The term bank is not intended to be limiting, but rather merely describe a potential embodiment of the disclosure. Further, it is noted that throughout the disclosure, the term electronic transaction may be used interchangeably with electronic interaction. The term electronic transaction is not intended to be limiting, but rather merely describe a potential embodiment of the disclosure.

As described above, the prevalence of electronic interactions (e.g., electronic transactions) has increased in recent years. Unfortunately, along with the increase in electronic transactions, the number of unauthorized electronic transactions has also increased. One aspect of such unauthorized electronic transactions relates to one or more of the parties involved in the electronic transactions using an identity not their own and/or that they are not authorized to use during the electronic transaction. In other words, a person conducting an electronic transaction (e.g., a customer conducting an electronic transaction with a business or individuals conducting an electronic interaction on a social networking website) may not be who they claim to be.

The use of an unauthorized identity during an electronic transaction can pose risks for the other parties involved in the transaction. For example, in an electronic transaction wherein an individual is requesting sensitive information from an organization or business, if the organization or business provides the individual with the sensitive information, the business may be at risk if the customer is, in fact, using an unauthorized identity. For example, if an individual is requesting information from a government agency such as the Internal Revenue Service or Social Security Administration, and the individual is requesting the information using an unauthorized identity, the government agency may be liable if it provides that information to the individual using the unauthorized identity.

Similarly, in a typical electronic transaction wherein a customer of a business purchases a good or service from the business, if the business provides the good or service to the customer, the business may be at risk if the customer is using an unauthorized identity. For example, if the customer is using an unauthorized identity, then it is likely that other aspects of the transaction may be unauthorized. Hence, there is a risk of financial loss for the business. Further, the risks may be even more substantial if the business is providing products such as weapons (e.g., firearms or ammunition), alcohol, pharmaceuticals or prescription drugs, and the like. In such situations, the business would attempt to ensure that the customer purchasing the products is in fact who they claim to be and, further, meets requirements that business may set forth for purchasing such products (e.g., age requirements, geographic location requirements, and the like). If customer is using an unauthorized identity to obtain the items, the business may be liable if it provides the products to the individual using the unauthorized identity.

Another example of an electronic transaction which may pose a risk if one of the parties is using an unauthorized identity is with regard to social networking websites. In such social networking websites individuals may submit unauthorized information to create unauthorized profiles. The social networking sites may be held liable depending on the actions of the individuals creating the unauthorized profile. For example, individuals may, without authorization, pose as celebrities and the social networking sites may be held liable for libel or slander issues. Social networking sites may spend a large amount of money attempting to verify and validate the identities of the individuals who participate in the social networking websites.

In the above examples, it would be advantageous for the other parties to the electronic transaction (e.g., businesses, individuals, organizations, and the like) if they could obtain a level of assurance that the individual involved in an electronic transaction is, in fact, who they claim to be. Therefore, aspects of this disclosure relate to a system and method for providing a level of assurance that a party involved in an electronic transaction is, in fact, who they claim to be. Aspects of this disclosure relate to a system and method for providing a quantitative level regarding the identity of an individual that can provide a measure of assurance that a party involved in an electronic transaction is, in fact, who they claim to be.

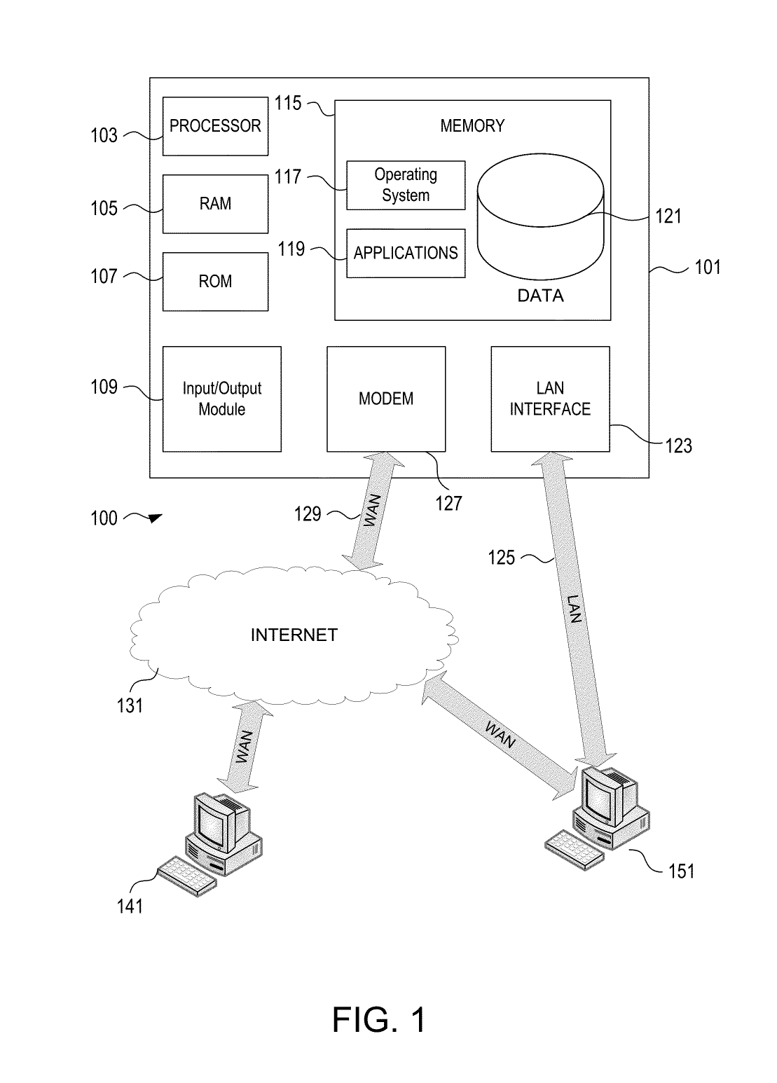

FIG. 1 illustrates an example of a suitable computing system environment 100 that may be used according to one or more illustrative embodiments of the disclosure. The computing system environment 100 is only one example of a suitable computing environment and is not intended to suggest any limitation as to the scope of use or functionality of the disclosure. Neither should the computing system environment 100 be interpreted as having any dependency nor requirement relating to any one or combination of components illustrated in the exemplary computing system environment 100.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and the like that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 101. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121. Alternatively, some or all of computer 101's computer executable instructions may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in FIG. 1 include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP and the like, is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the disclosure may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like.

Aspects of this disclosure relate to a system and method of creating an identity level. According to aspects of this disclosure, an identity level may be a numeric score that provides an indication of the validity of the identity of an individual conducting an electronic transaction. Thereby, an identity level may provide a measure of assurance that a party involved in an electronic transaction is, in fact, who they claim to be.

According to aspects of the disclosure, the identity level may be a numeric value within a range of 0-1000. Of course, this is merely one embodiment of a range of identity levels and according to other aspects of the disclosure, other ranges may be used. For example, according to other aspects of the disclosure, the identity level may be a numeric value within a range of 0-300 or 0-400. According to aspects of the disclosure, the greater the numeric value of the identity level, the greater the likelihood that the individual is, in fact, whom they are claiming to be. Conversely, if the numeric value of the identity level is lower, such a level may indicate that it is less likely that the individual is, in fact, whom they are claiming to be. For example, a level of 800 or more may indicate that the entity generating the identity level is providing a strong assurance that the individual involved in the electronic transaction is who they claim to be. In contrast, a level of 200 or less may indicate that the entity generating the identity level is providing a weak assurance that the individual involved in the electronic transaction is who they claim to be. Hence, it is understood, that the identity level provides a quick and efficient way to provide an indication of the likelihood or probability that an individual involved in an electronic transaction is, if fact, who they say the are. It is noted, that according to aspects of the disclosure, the identity level may include additional information such as the organization generating the identity level.

Further, by using a range of numeric values other parties to the electronic transactions, (e.g., business, individuals, organizations) may establish their own numeric threshold of how comfortable they are with the assurance of the identity of the individual conducting the electronic transaction. Such a threshold may relate to their level of risk tolerance. Based on the comparison of the identity level and their threshold, the customer may be approved or disapproved to proceed with the electronic transaction.

According to aspects of the disclosure, the identity level may be used during the electronic transaction. For example, in the above described example of an individual requesting information from the Social Security Administration, the Social Security Administration may contact one or more services that create and provide identity levels (e.g., a bank or other business) to determine if the one or more services can provide an identity level for that individual. For example, this may be done electronically and automatically upon the individual submitting the request from the Social Security Administration. Of course, it may be done manually as well. If, in response to the Social Security Administration's inquiry, the Social Security Administration receives an identity level regarding that particular individual from the one or more services, then the Social Security Administration can review the identity level and determine whether they should provide the information to the individual in response to the inquiry.

Alternatively, according to other aspects of the disclosure, the identity level may be provided by the individual when they are inputting information for conducting an online transaction. For example, the user interface for the online transaction may contain a field in which the customer can insert the identity level. Further, the user interface for the online transaction may contain a field in which the customer can insert a means for verifying the identity level. For example, user interface for the online transaction may contain a field in which the customer can insert contact information for the verifying source (e.g., a bank), an electronic attachment or the like (e.g., a PDF-type document of a certificate or other verification provided by the verifying source), a hyperlink to a computer system of the verifying source through which the verifying source may verify the level. Alternatively, or additionally, the other party in the electronic transaction may independently contact the organization who provided the identity level to verify the level.

According to aspects of the disclosure, an entity generating an identity level may leverage information it already has about an individual in order generate the identity level. For example, according to particular aspects of this disclosure, the business generating the identity level may be a bank. As will be described below, in such a situation, the bank can leverage information the bank already has about their customer in order to determine how certain the bank is of their customer's identity and, thereby, generate the identity level. It is noted that a bank may be in a unique situation for generating an identity level for one of its customers. For example, the bank may have relevant information about each of its customers that can be used in verifying the identity of the customer. For example, after the passage of the “Know Your Customer” legislation, banks are also in a better position to leverage such knowledge for identification purposes.

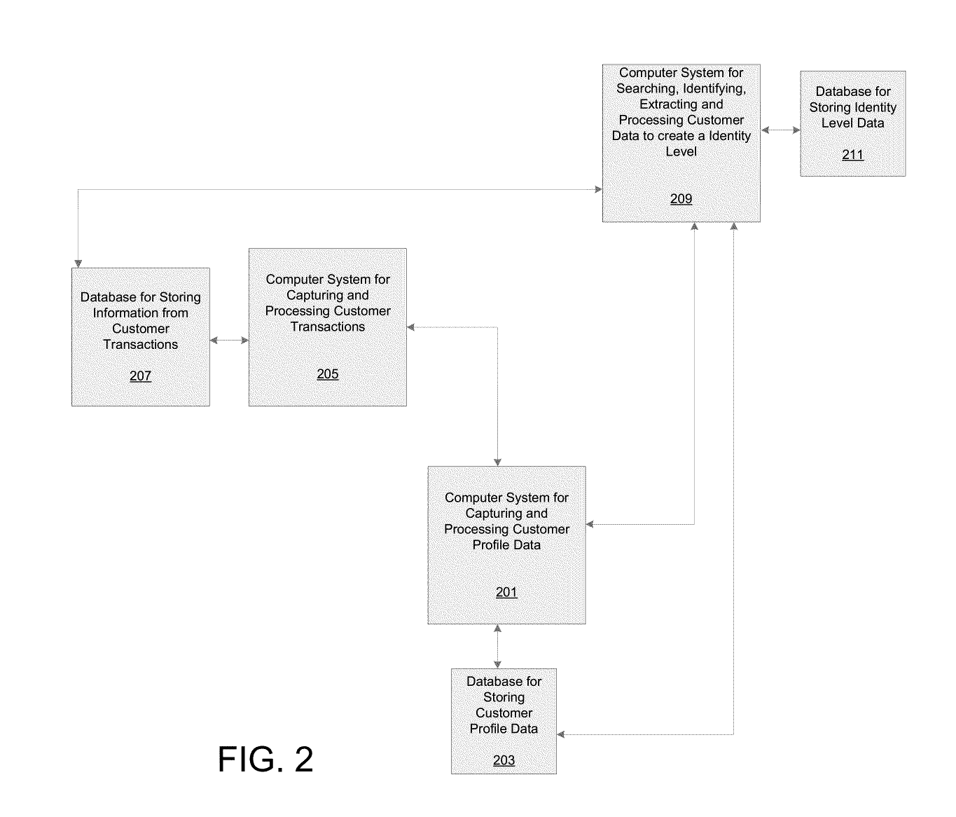

According to aspects of this disclosure, a bank may have one or more computer systems that captures and stores such information about a customer and, therefore, the bank may leverage the information in order to ascertain and identify information about their customers to determine how certain the bank is of their customers' identities and, thereby, generate identity levels for their customers. FIG. 2 illustrates a block diagram of a computing environment in which certain aspects of the present disclosure may be implemented. As seen in FIG. 2, a bank may have one or more computer systems 201 that are used for capturing and processing data related to customer profiles. Further, as seen in FIG. 2, a bank may have one or more computer systems 205 that are used for capturing and processing data used in financial transactions (e.g., online transactions).

According to aspects of the disclosure, a bank may create a customer profile for customers of the business. For example, according to aspects of this disclosure, a bank may have one or more computer systems 201 that are used for capturing and processing data related to the above described current customers' profiles. For example, a bank may have one or more computer systems 201 that are used for capturing and processing data about customers and their financial relationships with the bank, such as: customer name, address, telephone number, email address, age, credit score, income, debt, place of employment (and its contact information, such as address, telephone numbers, and the like), the type of financial relationship/account (e.g., a loan, insurance, savings account, checking account, and the like), term of the relationship (e.g., term of a loan, the time current customer has been with the bank, and the like), and the like The computer systems 201 used for capturing and processing customer profile data, may be configured to allow customers to input such customer profile data (e.g., via a web based system) or allow bank employees to enter such customer profile data. Further, the computer systems 201 may include one or more databases 203 for storing the customer profile data. For example, if the customer or bank employee enters such customer profile data, then the customer profile data may be stored in a database 203 associated with the computer systems 201 used for capturing and processing customer profile data. Also, the computer systems 201 used for capturing and processing current customer profile may be configured to transmit or receive the customer profile data (e.g., to/from other computer systems or databases within the bank).

According to aspects of the disclosure, the customer profile may also include information on the identity of the customer, such as: whether the customer has signed a signature card with the bank, whether the customer opened one or more accounts in person or electronically, whether the customer has ever conducted an in person counter transaction, whether the customer has ever conducted a transaction wherein a photo identification has been presented to and verified by the bank, and the like. Such information may be ascertained by the bank throughout the bank's financial relationship with the customer and stored in the customer profile.

According to aspects of the disclosure, one or more computer systems 205 may be used for capturing and processing data from financial transactions (online transactions). Such computer systems 205 may be configured to allow customers to input data regarding the financial transactions, such as: routing numbers, account numbers, payee information, payer information, and the like. Further, the computer systems 205 may be configured to transmit and receive funds using the routing numbers, account numbers, payee information, payer information, and the like, inputted by the customers. According to aspects of this disclosure, when the customer of the bank makes an online payment, the computer system 205 may extract such data (e.g., the payee information (alternatively the computer system may extract a routing number and an account number to identify the payee of the online transaction) payor information, routing numbers, account numbers, and the like).

Additionally, the computer systems 205 used for capturing and processing data from financial transactions may include one or more databases 207 for storing the data from the transactions including routing numbers, account numbers, payee information, payer information, and the like. For example, if the customer conducts a single online transaction or schedules recurring automatic online transactions, routing numbers, account numbers, payee information, payer information, and the like may be captured and stored in a database 207 associated with the one or more computer systems 205 used for capturing and processing data from transactions. Also, the computer systems 205 used for capturing and processing data from transactions may be configured to transmit the data, such as routing numbers, account numbers, payee information, payer information, and the like (e.g., to other computer systems or databases within the bank, such as the customer profile computer system and database 201, 203).

It is noted that according to aspects of the disclosure, the one or more computer systems 205 may be used for capturing and processing data from other financial transactions, such as checks. For example, such computer systems 205 may be configured to retrieve from the checks, the routing numbers, account numbers, payee information, payer information, and the like. For example, the computer systems 205 may include one or more scanning devices which scan paper checks and create electronic images of the paper checks that the computer systems 205 will store in one or more databases. Further, the computer systems 205 may be configured to extract and read the routing numbers, account numbers, payee information, payer information, and the like, from the paper check or the electronic image of the paper check (e.g., Optical Character Recognition (OCR) software or the like). Further, it is noted that other financial transactions (e.g., wire transfers, balance transfers, and the like) may be used in a similar manner, to ascertain and identify similar information.

According to aspects of the disclosure, the bank may utilize information in the customer profiles and information from the customer's financial transactions in order to create an identity level. For example, according to aspects of this disclosure, the bank may leverage the above described information to ascertain characteristics regarding the customer's identity, behavior, propensities and risk. Further, the bank may create one or more individual characteristic levels for each of these categories based upon such information. For example, according to aspects of the disclosure, the bank may create an individual characteristic level for each of an identity characteristic, a behavior characteristic, a propensity characteristic and a risk characteristic of the customer. The bank may use one or more algorithms for creating the individual characteristic levels for each of the characteristics. It is noted that, according to aspects of the disclosure, the individual characteristic levels may be a numeric value. Further, it is noted that while four individual characteristic levels are described below, according to aspects of the disclosure, other categories of characteristics may be used as desired. Further, according to aspects of the disclosure, the same information used to create one of the individual characteristic levels may relate to other individual characteristic levels and, therefore, such information may overlap between individual characteristic levels. Further, different individual characteristic levels and categories may be used or combined as desired.

According to aspects of the disclosure, the individual characteristic levels for the above described characteristics may include information ascertained from data stored in the customer profile database 203 or stored in database for storing information from the customer's financial transactions 207. For example, with regard to the individual characteristic level for the identity characteristic, the bank may leverage information such as: whether the customer has ever conducted an in-person transaction with the bank, whether the customer has ever conducted an in-person transaction wherein a photo identification has been presented to and verified by the bank, whether the customer has signed a signature card with the bank, the time period since the customer's most recent transaction, the length, or term, of the customer's relationship with the bank, the amount of business or number of accounts the customer has with the bank, whether the customer has references with whom the bank has verified information (e.g., whether the customer is in a joint account with the another customer whose identity the bank has already verified or who has an identity level above a predetermined identity level), whether the customer can answer security questions related to the customer's past correctly, and the like.

According to one or more aspects of the disclosure, a bank may have one or more computer systems 209 that are configured to create and maintain identity levels. According to aspects of the disclosure, computer system 209 may search for, identify, extract, or otherwise receive, and process data from the above described customer profile database 203 or database for storing information from the customer's financial transactions 207. For example, the computer system 209 may search the customer profiles stored in the customer profile database 203 and/or the database for storing information from the customer's financial transactions 207 for the above described information. Further, according to aspects of the disclosure, computer systems 213 may be configured to retrieve the above described information from the customer profiles or customer transaction information.

According to aspects of the disclosure, in order to generate the individual characteristic levels, computer system 209 may be configured to process data received from the customer profiles or customer transaction information. Further, according to aspects of this disclosure, computer system 209 may be configured to determine a level for each of the individual characteristics (e.g., an identity characteristic, a behavior characteristic, a propensity characteristic and a risk characteristic of the customer). According to aspects of the disclosure, in order to generate such an individual characteristic level, the computer system 209 may provide the customer with a base number (e.g., 50 points). Further, the computer system 209 may be configured to analyze the data that is electronically received from the databases 203, 207 based on a predefined criteria in order to generate the individual characteristic level. For example, based on various factors, the bank may increase or decrease the level by a predetermined amount.

By way of example, an illustrative method or process for generating an individual characteristic level for the identity characteristic according to aspects of the disclosure will be described below. According to aspects of the disclosure, in order to generate the individual characteristic level for the identity characteristic, the computer system 209 may provide the customer with a base level (e.g., 200 points). Further, the computer system 209 may be configured to analyze the data that is electronically received from the databases 203, 207 and modify the based number accordingly. For example, according to this illustrative example, the process may determine whether the customer has ever conducted an in-person transaction with the bank. If so, then the base level may be increased by 50 points. If not, then the base level may be decreased by 10 points. Thereafter, the process may determine whether the customer has ever conducted an in-person transaction wherein a photo identification has been presented to and verified by the bank. If so, then the level may be increased by 50 points. If not, then the level may be decreased by 10 points. Thereafter, the process may determine whether the customer has signed a signature card with the bank. If so, then the level may be increased by 50 points. If not, then the level may be decreased by 10 points. Thereafter, the process may determine the time period since the customer's most recent transaction. If the most recent transaction was within a predetermined time (e.g., a month or a year), the level may be increased by 50 points. If not, then the level may be decreased by 10 points. Thereafter, the process may determine the length, or term, of the customer's relationship with the bank. If the length, or term, of the customer's relationship with the bank is greater than a predetermined time (e.g., 1 year or 2 years), then the level may be increased by 50 points. If not, then the level may be decreased by 10 points. Thereafter, the process may determine the amount of business the customer has with the bank. If the amount of business is greater than a predetermined amount (e.g., $10,000 or $100,000), then the level may be increased by 50 points. If not, then the level may be decreased by 10 points. Thereafter, the process may determine the number of accounts the customer has with the bank. If the number of accounts is greater than a predetermined amount (e.g., 3 or 4 accounts), then the level may be increased by 50 points. If not, then the level may be decreased by 10 points. Thereafter, the process may determine whether the customer has references with whom the bank has verified information (e.g., whether the customer is in a joint account with another customer whose identity the bank has already verified or who has an identity level above a predetermined identity level). If so, then the level may be increased by 50 points. If not, then the level may be decreased by 10 points. Thereafter, the process may determine whether the customer has answered security questions related to the customer's past correctly (e.g., during a phone transaction). If so, then the level may be increased by 50 points. If not, then the level may be decreased by 10 points. Of course, these are just examples and other data and point totals may be used additionally or alternatively.

Once all the data has been analyzed based on the predefined criteria, the individual characteristic level for the identity characteristic may be calculated by the computer system 209 by totaling all points for each of the respective factors described above and combining that total with the customer's base number. For example, in the above example, if the customer had scored 50 points for each category, then the identity level would be 650. In other words, the total of the base level of 200 with the 450 points due to the increases for the different categories. The computer system 209 may be configured to store such individual characteristic level information in the identity level database 211. It is noted that in order to maintain the individual characteristic level, the computer system 209 may be configured to update the individual characteristic level, by performing the above process periodically. In this way, the individual characteristic level may be dynamic.

It is noted that the above described illustrative process is merely a simplistic example to aid the reader in understanding an aspect of the disclosure and is not intended to be limiting. For example, according to such aspects of this disclosure, the process for determining the level may include various other more complicated routines and processes, including: calculating weighted averages or other weighted calculations, averaging point totals of different categories, assigning different values or weighted percentages to the categories, and the like.

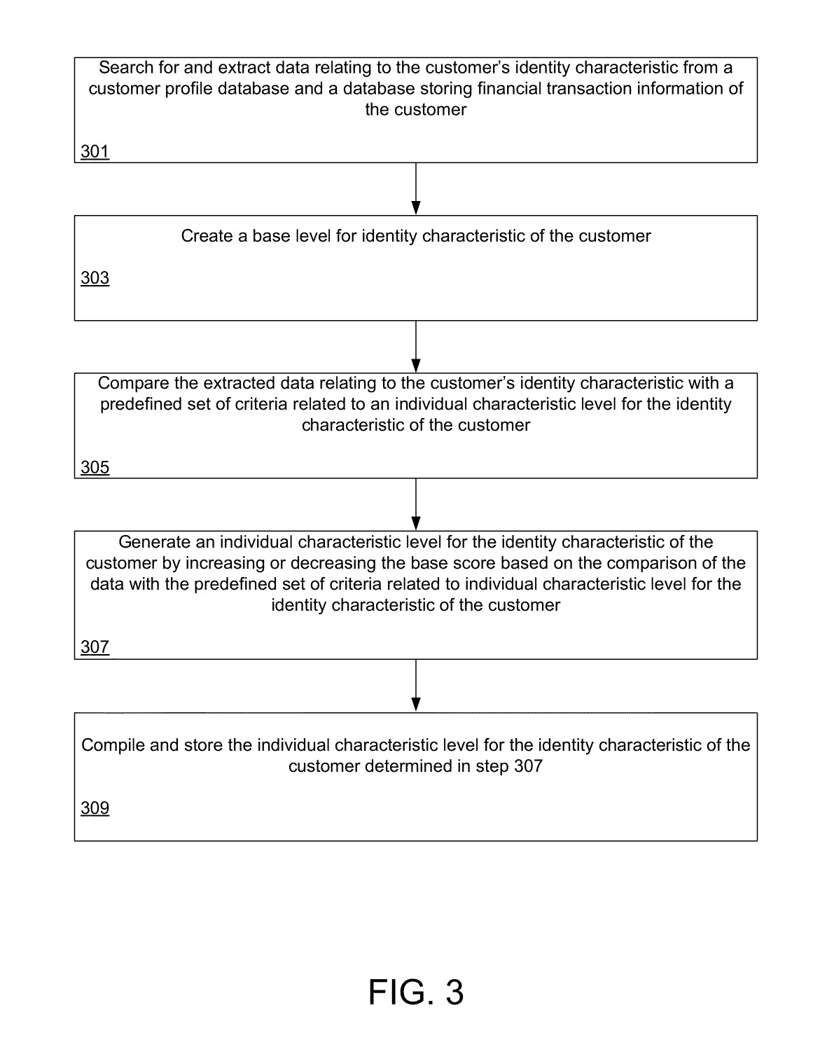

FIG. 3 is a flow chart which illustrates an illustrative method for creating an individual characteristic level for according to aspects of the disclosure. As seen in FIG. 3, the individual characteristic level is for the identity characteristic of the customer. It is noted that similar methods may be used for other individual characteristic levels. In step 301, the bank may use a computer system 209 to search the customer profile database and a database storing financial transaction information of the customer for data relating to the customer's identity characteristic. For example, the computer system 209 may electronically receive data from a customer profile database or a database storing financial transaction information of the customer. In step 303, the computer system may create a base level for the customer. In step 305, the computer system 209 may compare the data with a predefined set of criteria related to individual characteristic level for the identity characteristic of the customer. In step 307, the computer system 209 may generate an individual characteristic level for the identity characteristic of the customer by increasing or decreasing the level based on the comparison of the data with a predefined set of criteria related to individual characteristic level for the identity characteristic of the customer. In step 309, the computer system 209 may compile and store the individual characteristic level for the identity characteristic of the customer determined in step 307.

According to aspects of the disclosure, similarly to the above described individual characteristic level of an identity characteristic of a customer, the system and method may create an individual characteristic level for the behavior characteristic of a customer. The individual characteristic level for the behavior characteristic may include information ascertained from data stored in the customer profile database 203 or stored in database for storing information from the customer's financial transactions 207. For example, the bank may use financial transactions, such as online transactions, to ascertain and identify behavior of the customer.

According to aspects of the disclosure, the bank may leverage such behavioral information about the customer in order to generate an individual characteristic level for the behavior characteristic of the customer. For example, according to aspects of the disclosure, the bank may identify financial transactions related to the customer's account. The bank may identify the payee to which the financial transactions are paid or the payor from which financial transactions are received. The bank may capture such payee/payor information and store such information in the database 207. The bank may determine if any of the payor or payee information relates to individuals who are already known to be unauthorized actors, on one or more watch lists, and the like. The bank may leverage such information in creating and maintaining an individual characteristic level for the behavior characteristic of the customer.

For example, according to aspects of the disclosure, in order to generate and maintain the individual characteristic level for the behavior characteristic of the customer, computer system 209 may be configured to process data received from the customer profiles or customer transaction information. Further, according to aspects of this disclosure, computer system 209 may be configured to determine a level for the behavior characteristic in a manner similar to that described above for the determining a level for the identity characteristic. For example, a base level may be provided and the level may be increased or decreased based on the criteria relating to the behavior characteristic of a customer (such as those behavior factors described above).

According to aspects of the disclosure, similar to the above described individual characteristic level of an identity or behavior characteristic of a customer, the system and method may create an individual characteristic level for the propensity characteristic of a customer. The individual characteristic level for the propensity characteristic may include information ascertained from data stored in the customer profile database 203 or stored in database for storing information from the customer's financial transactions 207. For example, the bank may use financial transactions, such as online transactions, to ascertain and identify behavior of the customer.

According to aspects of the disclosure, the bank may leverage such propensity information about the customer in order to generate an individual characteristic level for the propensity characteristic of the customer. For example, according to aspects of the disclosure, the bank may identify trends in the customer's financial transaction history to determine propensity characteristics of the customer. For example, the bank may determine “normal” transactions for the customer (e.g., amounts of funds, payor and payees with which the customer conducts financial transactions, times and dates of financial transactions, regularity of financial transactions, how often a customer conducts financial transactions (e.g., how often a customer transfers funds), whether the customer has ever conducted an online transaction, whether the customer has ever conducted an transaction via the telephone, and the like) and leverage such characteristics to determine “normal” propensities of the customer. Similarly, the bank may also determine geographic information (e.g., locations (e.g., states, area codes, and the like) from which the customer usually conducts transactions or requests information), timing information (e.g., times of day or days during the month when the customer usually conducts transactions or requests information), and the like in identify trends in the propensities of a customer.

According to aspects of the disclosure, in order to generate and maintain the individual characteristic level for the propensity characteristic of the customer, computer system 209 may be configured to process data received from the customer profiles or customer transaction information. Further, according to aspects of this disclosure, computer system 209 may be configured to determine an individual characteristic level for the propensity characteristic in a manner similar to that described above for the determining a level for the identity characteristic. For example, a base level may be provided and the level may be increased or decreased based on the criteria relating to the propensity characteristic of a customer (such as those behavior factors described above).

According to aspects of the disclosure, similar to the above described individual characteristic level of an identity, behavior, or propensity characteristic of a customer, the system and method may create an individual characteristic level for the risk characteristic of a customer. The individual characteristic level for the risk characteristic may include information ascertained from data stored in the customer profile database 203 or stored in database for storing information from the customer's financial transactions 207. For example, the bank may use financial transactions, such as online transactions, to ascertain and identify risk associated with the identity of the customer.

According to aspects of the disclosure, the bank may leverage such risk information about the customer in order to generate an individual characteristic level for the risk characteristic of the customer. For example, according to aspects of the disclosure, the bank may identify financial transactions related to the customer's account. The bank may identify the amount of funds usually involved with the customer's financial transactions. If the customer's transactions involve a relatively large amount of funds, then the customer may be more prone to identity theft than other customers who conduct financial transactions with smaller amounts of funds. Further, the bank may identify the type of transactions usually involved with the customer's financial transactions. If the customer conducts a large amount of online transactions (e.g., online investing or trades), then the customer may be more prone to identity theft than other customers who do not conduct a large amount of online transactions. Similarly, the bank may capture net worth information of the customer from the account information in the customer profile. If the bank determines that the customer is a high net worth individual, then the bank may consider the customer more likely to be a target for identity theft. Additionally, the bank may capture geographic information of the customer from the customer profile. The bank may determine if the customer's address is in an area prone to identity theft. Additionally, the bank may capture information regarding of the customer from the customer profile. The bank may determine if the customer's address is in an area prone to identity theft. The bank may leverage such information in creating and maintaining an individual characteristic level for the risk characteristic of the customer.

According to aspects of the disclosure, in order to generate and maintain the individual characteristic level for the risk characteristic of the customer, computer system 209 may be configured to process data received from the customer profiles or customer transaction information. Further, according to aspects of this disclosure, computer system 209 may be configured to determine a level for the risk characteristic in a manner similar to that described above for determining a level for the identity, behavior and propensity characteristics. For example, a base level may be provided and the level may be increased or decreased based on the criteria relating to the risk characteristic of a customer (such as those risk factors described above).

According to aspects of the disclosure, each of the individual characteristic levels for the identity, behavior, propensity and risk characteristics may be used separately. In other words, any or all the levels may be provided separately. The person or business using the levels to evaluate the validity of the identity of the individual conducting the online transaction may use any or all of the levels to determine whether they have been assured the customer is who they claim to be. Further, as described above, different individual characteristic levels and categories may be used or combined as desired in order to determine whether they have been assured the customer is who they claim to be.

According to aspects of the disclosure, the system and method for generating and maintaining an identity level may use one or more of the individual characteristic levels for the identity, behavior, propensity and risk characteristics in order to create an overall cumulative identity level. For example, according to aspects of the disclosure, the computer system 209 may combine the information in the above described individual characteristics and then correlate such information in order to determine an overall cumulative identity level. According to such aspects of this disclosure, the computer system 209 may be configured to process such information in manner described above and then generate an overall cumulative identity level for the customer.

For example, the computers system 209 may average the individual characteristic levels of the individual characteristics or perform more complicated processes (e.g., weighted averages or other weight calculations, and the like) generate an overall cumulative identity level for the customer based on the individual characteristic levels for the identity, behavior, propensity and risk characteristics. According to aspects of this disclosure, the computer system 209 may be configured to store such identity levels in the identity levels database 211.

An illustrative process for the creating an identity level according to aspects of the disclosure will be discussed below. It is noted that in this illustrative example, the identity level is generated based on individual characteristic levels for two categories, namely, each of the identity and risk characteristics. It is noted that as discussed above, there may be overlap between the characteristics and traits and, therefore, in this example, the information related to the behavior and propensity characteristics of a customer (which are discussed above) may in incorporated into the individual characteristic levels generated for each of the identity and risk characteristics. For example, some of the behavior and propensity criteria discussed above may be incorporated into each of the identity and risk characteristics when creating the individual characteristic levels for each of the identity and risk characteristics.

Once the individual characteristic level for each of the identity characteristic and risk characteristic is created, the two individual characteristic levels may be used to create the identity level (i.e., the overall cumulative identity level). For example, as discussed above, the individual characteristic level for the identity characteristic and the individual characteristic level for the risk characteristic may be averaged (or other more complicated processes (e.g., weighted averages or other weighted calculations, and the like)) may be used to generate an overall cumulative identity level for the customer.

Further, according to aspects of the disclosure, the individual characteristic level for the identity characteristic may be placed in a range which reflects the level of assurance, or confidence, that the organization generating the individual characteristic level has that the individual is who they claim to be. By way of a simplistic illustrative example, the ranges may be 0-3, 4-6 and 7-10, wherein 0-3 indicates a low level of assurance, 4-6 indicates an intermediate level of assurance and 7-10 indicates a high level of assurance. It is noted that the difference between consecutive numbers may indicate a large difference in the level of assurance (e.g., the difference between a level of 4.6 and a level of 5.1 may indicate a large difference in the level of assurance). Further, according to aspects of the disclosure, the individual characteristic level for the risk characteristic may be generated in a similar manner. For example, the ranges may be 0-3, 4-6 and 7-10, wherein 0-3 indicates a high level of risk, 4-6 indicates an intermediate level of risk and 7-10 indicates a low level of risk.

According to aspects of the disclosure, the individual characteristic level for the identity characteristic and the individual characteristic level for the risk characteristic may be weighted such that a low level in one area (e.g., risk) may provide a low identity level (i.e., the overall cumulative identity level) even if the individual characteristic level for the other characteristic is extremely high. Further, as discussed above, the individual characteristic levels (e.g., for the identity characteristic and the risk characteristic) may be dynamic. For example, if a customer has recently engaged in activities that cause his risk to increase, such a risk may be reflected in the individual characteristic level for the risk characteristic rather quickly. In contrast, once a customer has achieved a high level of assurance that they are who they claim to be, such a level is not likely to change as quickly or dramatically over the course of a short amount time.

According to aspects of the disclosure, the one or more of the factors involved in determining an identity level may be transparent to the bank customer and to the parties requesting the identity level (e.g., a business involved in an electronic commercial transaction with the customer). For example, if a customer may be able to determine why their level is at a particular level and also understand how to increase the identity level. In other words, the customer may realize that if they come into a branch of the bank and execute a signature card, then the customer may be able to increase their identity level. Similarly, a business may also be able to see exactly how the identity level was achieved. For example, the business may see that a customer has never conducted an in-person transaction with the bank. Therefore, regardless of the customer's identity level, the particular business may not approve the transaction.

According to aspects of the disclosure, industry knowledge (e.g., FICO scores, and the like) may be used as factors in creating an identity level, or may be used separately from identity levels.

According to aspects of this disclosure, a business, organization, individual or other party may request an identity level from the bank (or other identity level generator) for an individual with whom they are conducting an electronic transaction. According to aspects of this disclosure, the business, organization, individual or other party can request the identity level on a per transaction basis. Alternatively, according to aspects of this disclosure, the business, organization, individual or other party may have a subscription to the bank's identity level database and thereby check the identity level of individuals with whom they are conducting an electronic transaction at any time. Each of these concepts (e.g., the per transaction request or the subscription) may be associated with a fee chargeable by the bank to the party requesting the identity level.

In order to provide the reader with additional detail on how the identity level may be used, described below is an example method for obtaining and using the identity level for an individual participating in an electronic transaction.

According to aspects of the disclosure, businesses or other organizations offering electronic transactions may include a user interface into which a customer conducting an electronic transaction with the business can insert information regarding himself or herself. For example, such a user interface may include fields for the individual's name, address, financial information (e.g., credit or debit card information), and the like. Once the business has received the information from the customer through the user interface, business may contact the identity level generating service (e.g., a bank, a business, a centralized identity bureau, and the like) in order to obtain an identity level for the customer.

The business or other organization may use the obtained identity level to determine if the identity level meets its internal predefined threshold for approving the customer for conducting the transaction. For example, a business may set a predefined threshold of an identity level of 800 for approving the customer for conducting the transaction. If the customer's identity level is equal to or above 800, the customer may be approved to conduct the transaction. Alternatively, if the customer's identity level is less than 800, the customer may not be approved to conduct the transaction.

According to aspects of the disclosure, more than one bank, business, organization, and the like, may create identity levels. For example, several banks may each create their own identity levels for a particular customer. Further, information regarding each of these identity levels from the various banks may be transmitted to a central database (e.g., the identity bureau database) which is accessible via a website. Hence, such a central database would contain information from a plurality of banks. Further, in addition to banks, other organizations and business which have information regarding an individual's identity may create their own identity levels for an individual and contribute this information to central database. For example, the above described social networking sites, or merchants, such as department stores may be included. It is noted that some of organizations creating the identity levels may be less sophisticated or have less information regarding an individual. Therefore, such organizations may be “capped” on a maximum identity level they may provide the individual. For example, a social networking site or merchant may only be able to provide a maximum identity level of 300 for an individual.

According to aspects of this disclosure, the identity levels from different business may be incorporated with each other. For example, an identity level of 600 from a bank and an identity level of 200 from a social networking site may be combined to provide the individual with a total identity level of 800. However, whether or not this combined level is acceptable may be dependent of the organization or business conducting the electronic transaction with the individual. As another example, an identity level of 600 from a bank and an identity level of 200 from a social networking site may be averaged to provide the individual with a total identity level of 400. However, whether or not this averaged level is acceptable may be dependent of the organization or business conducting the electronic transaction with the individual. It is noted that according to aspects of this disclosure, identity levels from different business may be incorporated with each other in other ways as well.

By way of another example, according to aspects of the disclosure, an organization or business conducting an electronic transaction with an individual, may use an identity level from a first bank, or company, as an initial identity level and then may supplement the initial identity level with an identity level from a third party (e.g., a second bank or company). For example, a first bank may provide the organization or business with a first identity level of 400, which may not be high enough for the organization or business conducting the electronic transaction with the individual to authorize the electronic transaction. However, the organization or business conducting the electronic transaction with the individual may request an identity level from a second bank in order to supplement (e.g., potentially strengthen or raise) the initial identity level of 400 from the first bank. The second bank may provide a second identity level of 600. According the aspects of the disclosure, the organization or business conducting the electronic transaction with the individual, may use the second identity level provided by the second bank in combination with the first identity level provided by the first bank in order to determine an identity level for the individual. For example, the first and the second identity levels may be added, averaged, subjected to a weighted averaging process, or any other type of process the organization or business may wish to use to determine the new identity level. In this case, if the new identity level based on the combination of the first identity level provided by the first bank and the second identity level provided by the second bank is high enough (e.g., higher that a predetermined number), then the organization or business conducting the electronic transaction with the individual may authorize the electronic transaction.

Further, it is noted that the organization or business conducting the electronic transaction with the individual may provide tiered layers of transactions that may be conducted by the individual depending on the identity level. For example, if the individual has a level between 300-600, the individual may be able to conduct lower risk electronic transactions (e.g., checking account balances or conducting electronic transactions below a predetermined valued, such as $50.00), but may be prevented from conducting higher risk electronic transactions (e.g., receiving sensitive information, conducting electronic transactions above a predetermined valued, such as $50.00). Such higher risk electronic transactions may only be completed if the individual has an identity level of at least 800.

It is noted that the system for generating an identity level may be an electronically based system, such as a web-based application. For example, the system may include a computer (such as described above), a network of computers, software that configures a computer to perform the above described features, and the like. It is noted that according to aspects of the disclosure, the electronically based system for creating and maintaining identity levels may include one or more algorithms to perform such tasks automatically. In other words, the electronically based business system may create and maintain identity levels once the data has been electronically received.

It is noted that according to aspects of the disclosure, an identity level may be used in non-electronic transactions as well. For example, according to aspects of the disclosure, the identity level may be used in counter transactions or other in-person transactions. For example, according to aspects of the disclosure, if an individual presented a business or entity with credentials, the business or entity may use the identity level to confirm the authenticity of the credentials based on previous interactions or credentials that have been stored in the system.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. It will also be appreciated and understood that modifications may be made without departing from the true spirit and scope of the present disclosure. The description is thus to be regarded as illustrative instead of restrictive on the present disclosure.

1. A system, comprising:
an identity level generating computing device having a first processor; and
a first memory storing computer executable instructions that, when executed, cause the identity level generating computing device to:
electronically receive, from a first computer system of a first entity, information associated with a user of the first entity and generating a user profile based on the received information;
electronically receive, from a second computer system of the first entity, record data of the user of the first entity;
based on the received information associated with the user, generated user profile, and record data, determine an individual characteristic level for the user of the business for at least two individual characteristics selected from a group comprising: an identity of the user, a behavior of the user, a propensity of the user, and a risk associated with the user's identity, determining the individual characteristic level for the user for the at least two individual characteristics including:
generating a base level value for each of the at least two individual characteristics;
analyzing the received information associated with the user, generated user profile, and record data, the analyzing including comparing the data with predefined criteria;
adjusting the base level value for each of the at least two individual characteristics based on the analyzed received information associated with the user, generated user profile, and record data to determine the individual characteristics level for each of the at least two individual characteristics;
generate an overall identity level of the user by determining an average of the individual characteristic level for each of the at least two individual characteristics of the user, the overall identity level of the user being an indication of a validity of an identity of the user; and
a second entity computing device, the second entity being different from the first entity and the second entity computing device including a second processor and a second memory storing computer executable instructions that, when executed, cause the second entity computing device to:
receive a request for a record from the customer;
automatically transmit, to the identity level generating computing device, a request for the overall identity level of the user to determine a validity of the identity of the user conducting the record with the second entity;
receive, from the identity level generating computing device, the overall identity level of the user;
compare the received overall identity level of the user to an identity level threshold of the second entity;
based on the comparison, responsive to determining that the overall identity level of the user is above the identity level threshold of the second entity, authorizing the requested transaction and conducting the requested transaction; and
based on the comparison, responsive to determining that the overall identity level of the user is not above the identity level threshold of the second entity, denying the requested transaction.

2. The system according to claim 1, wherein the received information associated with the user, generated user profile, and record data includes at least one of: a first data indicating whether the user has conducted an in-person record with a business, a second data indicating whether the user has conducted an in-person record wherein a photo identification has been presented to and verified by a business, and a third data indicating whether the user has signed a signature card with a business.

3. The system according to claim 1, wherein the received information associated with the user, generated user profile, and record data includes at least one of: a first data indicating whether the time period since the user's most recent record with a business is within a first predetermined time, a second data indicating whether the length, or term, of the user's relationship with a business is greater than a second predetermined time, a third data indicating whether the amount of business the user has with a business is greater than a predetermined amount, and a fourth data indicating whether the number of accounts the user has with a business is greater than a predetermined number.

4. The system according to claim 1, wherein the received information associated with the user, generated user profile, and record data includes at least one of: a first data indicating whether the user has references with whom a business has verified information and a second data indicating whether the user has answered security questions related to the user's past correctly.

5. The system according to claim 1, wherein the received information associated with the user, generated user profile, and record data includes at least one of: a first data indicating whether the user has conducted a record with a person who is already known to have committed unauthorized activity and a second data indicating whether the user has conducted a record with a person who is on a watch list.

6. The system according to claim 1, wherein the received information associated with the user, generated user profile, and record data includes at least one of: a first data indicating whether the user has conducted a record which is greater than a predetermined range related to an amount of funds the user uses in a typical transaction, wherein the range is determined based on the amounts in the user's records over a predetermined amount of time and a determination of whether the users has conducted a record with a person with whom the user has not conducted a record previously or within a predetermined amount of time.

7. The system according to claim 1, wherein the received information associated with the user, generated user profile, and record data includes at least one of: a first data indicating a user's net worth, a second data indicating whether a majority of a user's records are above a predetermined amount, and a third data indicating whether a user's address is located in a geographic location that is prone to identity theft.

8. The system according to claim 1, the identity level generating computing device further including instructions that, when executed, cause the computing device to:
electronically receive a second overall identity level of the user which has been generated by a third entity different from the first entity and the second entity,
adjust the overall identity level of the user based on the received second overall identity level.

9. The system according to claim 1, wherein the identity level threshold of the second entity is determined by the second entity.

10. An identity level generating computer comprising:
a processor; and
memory storing computer executable instructions that, when executed, cause the computer to generate the identity level for a user of a first entity, by:
electronically receiving, from a first computer system of the first entity, information associated with the user of the first entity and generating a user profile based on the received information;
electronically receiving, from a second computer system of the first entity, record data of the user of the first entity;
based on the received information associated with the user, generated user profile, and record data, determining an individual characteristic level for the user of the business for at least two individual characteristics selected from a group comprising: an identity of the user, a behavior of the user, a propensity of the user, and a risk associated with the user's identity, determining the individual characteristic level for the user for the at least two individual characteristics including:
receiving a base level value for each of the at least two individual characteristics;
analyzing the received information associated with the user, generated user profile, and record data, the analyzing including comparing the data with predefined criteria;
adjusting the base level value for each of the at least two individual characteristics based on the analyzed received information associated with the user, generated user profile, and record data;
generating an overall identity level of the user by determining an average of the individual characteristic level for each of the at least two individual characteristics of the user, the overall identity level of the user being an indication of a validity of an identity of the user;
receiving, from a third computer system of a second entity different from the first entity, a request for the generated overall identity level of the user to determine a validity of the identity of the user conducting a record with the second entity; and
transmitting the overall identity level of the user indicating the validity of the identity of the user to the third computer system of the second entity.

11. The identity level generating computer according to claim 10, wherein the received information associated with the user, generated user profile, and record data includes one of: a first data indicating whether the user has conducted an in-person record with a business, a second data indicating whether the user has conducted an in-person record wherein a photo identification has been presented to and verified by a business, and a third data indicating whether the user has signed a signature card with a business.

12. The identity level generating computer according to claim 10, wherein the received information associated with the user, generated user profile, and record data includes at least one of: a first data indicating whether the time period since the user's most recent record with a business is within a first predetermined time, a second data indicating whether the length, or term, of the user's relationship with a business is greater than a second predetermined time, a third data indicating whether the amount of business the user has with a business is greater than a predetermined amount, and a fourth data indicating whether the number of accounts the user has with a business is greater than a predetermined number.

13. The identity level generating computer according to claim 10, wherein the received information associated with the user, generated user profile, and record data includes at least one of: a first data indicating whether the user has references with whom a business has verified information and a second data indicating whether the user has answered security questions related to the user's past correctly.

14. The identity level generating computer according to claim 10, wherein the received information associated with the user, generated user profile, and record data includes at least one of: a first data indicating whether the user has conducted a record with a person who is already known to have committed unauthorized activity and a second data indicating whether the user has conducted a record with a person who is on a watch list.

15. The identity level generating computer according to claim 10, wherein the received information associated with the user, generated user profile, and record data includes at least one of: a first data indicating whether the user has conducted a record which is greater than a predetermined range related to an amount of funds the user uses in a typical record, wherein the range is determined based on the amounts in the user's records over a predetermined amount of time and a second data indicating whether the user has conducted a record with a person with whom the user has not conducted a record previously or within a predetermined amount of time.

16. The identity level generating computer according to claim 10, wherein the received information associated with the user, generated user profile, and record data includes at least one of: a first data indicating a user's net worth, a second data indicating whether a majority of a user's transactions are above a predetermined amount, and a third data indicating whether a user's address is located in a geographic location that is prone to theft.

17. The identity level generating computer according to claim 10, further including instructions that, when executed, cause the computer to:
electronically receive a second overall identity level generated by a third entity different from the first entity and the second entity; and
adjust the overall identity level based on the received second overall identity level.

18. A computer assisted method for providing an indication of a validity of an identity of a user conducting an electronic transaction, comprising:
generating an overall identity level for the user of a first entity by:
electronically receiving, from a first computer system of the first entity, information associated with the user of the first entity and generating a user profile based on the received information;
electronically receiving, from a second computer system of the first entity, record data of the user of the first entity;
based on the received information associated with the user, generated user profile, and record data, determining an individual characteristic level for the user of the business for at least two individual characteristics including an identity of the user and a risk associated with the user's identity, determining the individual characteristic level for the user for the at least two individual characteristics including the identity of the user and the risk associated with the user's identity including:
receiving a base level value for each of the at least two individual characteristics;
analyzing the received information associated with the user, generated user profile, and record data, the analyzing including comparing the data with predefined criteria;
adjusting the base level value for each of the at least two individual characteristics based on the analyzed received information associated with the user, generated user profile, and record data
generating an overall identity level of the user by determining an average of the individual characteristic level for each of the at least two individual characteristics of the user, the overall identity level of the user being an indication of a validity of an identity of the user;
storing the generated overall identity level in a database;
electronically receiving, from a third computer system of a second entity different from the first entity, a request for the overall identity level of the user to determine a validity of the identity of the user conducting a record with the second entity; and
transmitting the requested overall identity level of the user indicating the validity of the identity of the user to the third computer system of the second entity.

19. The computer assisted method of claim 18, wherein the computer is configured to transmit the requested overall identity level through a web based system on a publically accessible website.
